(19) United States
(12) Patent Application Publication
(10) Pub. No.: US 2004/0055780 A1
(43) Pub. Date: Mar. 25, 2004

(54) Combined suspension cable and electrical conductor

(76) Inventors: Susan Hakkarainen, Doylestown, PA (US); Bruce Belfer, West Allenhurst, NJ (US)

Correspondence Address: OSTROLENK FABER GERB & SOFFEN, 1180 AVENUE OF THE AMERICAS, NEW YORK, NY, 100368403

(21) Appl. No.: 10/443,934

(22) Filed: May 21, 2003

Related U.S. Application Data
(60) Provisional application No. 60/395,818, filed on Jul. 11, 2002.

(51) Int. Cl. H01B 7/00

(52) U.S. Cl. 174/120 R

(57) ABSTRACT

A combination mounting cable and electrical conductor for a suspended lighting fixture or other electrical apparatus which provides power to the fixture without visible conductors, formed of at least one insulated electrical conductor, a discrete second insulating layer surrounding the insulated conductor, and movable relative thereto, and a sheath surrounding the second insulating layer, the sheath being capable of bearing the weight of a lighting fixture suspended by the cable. The insulation on the conductor and the discrete second insulating layer are formed of a fluoropolymer material, and the weight bearing sheath is formed of braided or woven strands of metal such as stainless steel. Alternatively, the second insulating layer may be formed of an aramid material or fiberglass, and the inner insulator of any suitable material. In case, depending on the mechanical and dielectric properties of the materials, the two insulating layers need not be relatively movable. In one embodiment, the elements are all coaxial with each other. In a second embodiment, there are at least two insulated conductors in side-by-side relationship surrounded by the discrete second insulating layer and the weigh-bearing sheath.

This application claims priority to provisional application serial No. 60/395,818 filed Jul. 11, 2002.

### BACKGROUND OF THE INVENTION

1. Field of the Invention

The present invention relates a combined suspension cable and power conductor for a suspended electrical apparatus, and more particularly, to combined structure having a weight bearing outer portion and an internal electrical conductor for supporting and providing electrical power and data signals to the suspended apparatus, which eliminates the need for an unsightly external wire running along the suspension cable. The invention also relates to a combined suspension cable and power conductor which can be used with a mounting assembly that allows for gross adjustment of the position of the suspended apparatus at the time of wiring, and convenient fine adjustment of the position at a later time.

The invention is illustrated in the context of a suspended lighting fixture, maybe used equally well with other electrical apparatus such as signage, computer displays, telecommunications equipment, switches, controls, powered connection devices, theft control devices, sensors, medical equipment and any other equipment or device which requires both suspension and electrical connections for data signals and/or operating power.

2. Related Art

A suspended ceiling fixture or luminaire is typically mounted using a horizontal crossbar structure of some type attached to an electrical junction box, which in turn, is attached to a suitable weight-bearing structural member such as a ceiling joist. A canopy in the form of an inverted dome may be used to cover the mounting structure and the junction box to provide a finished appearance.

On such mounting assembly is of the type illustrated in copending U.S. provisional patent application No. 60/324,888, filed Sep. 26, 2001, and which is incorporated by reference herein as if fully set forth.

The fixture itself can be suspended from the mounting assembly in several different ways, depending on the size and shape of the fixture and/or the esthetic effect desired. For example, rigid hollow tubes or rods, threaded at the ends can be attached to the mounting assembly and the fixture by suitable locking nuts. Alternatively, decorative chains suitably attached to the mounting assembly and the fixture may be used. As a further alternative, stranded “wire rope” cables, connected by conventional cable grippers, can be employed.

When hollow tubes are employed, the required electrical conductors can pass through the tubes from the junction box to the fixture, and are thus not visible. When chains or cables are employed, however, there is no place to hide the wires, so they are generally threaded in the chain links, or secured to the cable and, in either case, are visible as they extend from the ceiling to the fixture.

Attempts have been made to avoid the use of separate wires and suspension cables by constructing composite cables having one or more insulated electrical conductors surrounded by a weight-bearing sheath. These, however, have met with limited success because of the need to satisfy conflicting requirements.

For example, the composite cable should have approximately the same diameter as conventional stranded wire rope for esthetic reasons, for convenient handling during installation and to accommodate standard wire rope grippers or other suitable gripping hardware. At the same time, the cable must have sufficient strength to support the weight of the fixture even though its interior is occupied by the non-weight bearing electrical conductor. Also, the design must permit mechanical connections to be made easily and reliably at both ends, and in particular, must minimize the risk that the conductor insulation will be damaged by attachment of the gripping hardware during installation or in normal use. Further, because of the close proximity of the conductor to a weight-bearing sheath that may be metallic, the risk of insulation failure due to manufacturing defects or handling must be minimized. In addition, the cable must be easy to cut and must not unravel excessively at the cut end. Further, the conductor material must be soft enough to minimize kinking and to straighten easily when the cable itself is straightened.

Further, all conducting parts of the fixture and mounting assembly must have a common ground and all of the conductors must have strain relief to satisfy typical local electrical code requirements, and safety standards of organizations such as Underwriter's Laboratories.

Another desirable feature would be that the cables can be used with a mounting assembly that permits gross adjustment of the position of the fixture while it is being wired, and fine adjustment afterwards without the need for disassembly or removal of parts already installed.

No satisfactory solution to these conflicting requirements appears has been available up to now.

It would be extremely desirable to have a composite cable structure which can be used both to suspend a lighting fixture and to provide electric power to the fixture from an overhead junction box without a separate visible electrical conductor, and that satisfies the above-described requirements.

### SUMMARY OF THE INVENTION

It is accordingly an object of the present invention to provide an improved mounting cable for a lighting fixture or other electrical apparatus.

Another object of the invention is to provide a composite cable for a suspended electrical apparatus which permits both suspension and delivery of electricity to the apparatus from an overhead junction box.

It is another object of the invention to provide a composite mounting cable for a suspended lighting fixture or the like which provides reliable mechanical support and invisible electrical wiring.

It is a further object of the invention to provide a composite mounting cable for a suspended lighting fixture or the like having one or more internal insulated electric wires and an external weight-bearing sheath.

It is also an object of the invention to provide such a composite mounting cable that can accommodate conventional stranded-wire cable grippers or other gripping hardware with minimized risk of damage to the insulation of the internal wire during installation or normal use, or electrical leakage due to cracks or other insulation defects.

It is a further object of the invention to provide a composite mounting cable and a mounting system that allow all conducting parts to have a common ground.

It is another object of the invention to provide such a composite mounting cable and a mounting system in which all conductors have strain relief.

It is yet another object of the invention to provide such a composite mounting cable which is easy to cut.

It is a still further object of the invention to provide such a composite mounting cable in which the weight-bearing element will not unravel excessively when cut.

It is also an object of the invention to provide such a composite mounting cable and mounting system that will allow for gross adjustment at time of wiring and fine adjustment later.

It is also another object of the invention to provide such a composite mounting cable where simple electrical connections can be made without piercing the conductor.

It is yet a further object of the invention to provide such a composite mounting cable that can accommodate conventional stranded-wire cable grippers or other gripping hardware where the conducting material is soft enough to minimize kinking and allow the ability to straighten the cables with minimal effort.

The above-stated objects are achieved according to the invention by providing a cable having at least one insulated internal conductor formed of fine stranded solid wire, a discrete second layer of electrical insulation surrounding the insulated electrical conductor, and a braided metal sheath surrounding the second layer of electrical insulation.

The two insulating layers are preferably formed of a material such as a fluoropolymer that has good dielectric properties and a low coefficient of friction. The insulation surrounding the conductor fits tightly so there is no relative movement between the two. Preferably, however, the discrete second insulating layer fits more loosely around the insulated conductor, and also within the surrounding sheath. so that relative movement between the two insulating layers and between the second insulating layer and the outer sheath is possible when the gripping hardware is attached to the cable. Alternatively, the second insulating layer may be formed of a tough material such as an aramid or fiberglass, and the inner layer may be formed of any suitable insulator. In either case, the outer insulator may be fitted snugly around the insulated conductor, or even bonded to it, depending on the dielectric and/or mechanical properties of the insulating material.

The external metal sheath is preferably formed of braided or woven metal such as stainless steel, but may also be formed of fibers of a braided or woven aramid material.

Other features and advantages of the present invention will become apparent from the following description of the invention and the accompanying drawings.

### BRIEF DESCRIPTION OF THE DRAWINGS

FIG. 1 is schematic drawing of a suspension assembly for a suspended fixture employing four suspension cables according to the invention.

FIG. 2 is a cut-away view of the composite cable according to a first embodiment of the invention.

FIG. 3 is a cross-sectional view of the cable shown in FIG. 2.

FIG. 4 is a schematic side elevation showing the manner in which the cable can be connected to a conventional cable gripper.

FIG. 5 is a cut-away view of the composite cable according to a second embodiment of the invention.

### DETAILED DESCRIPTION OF THE INVENTION

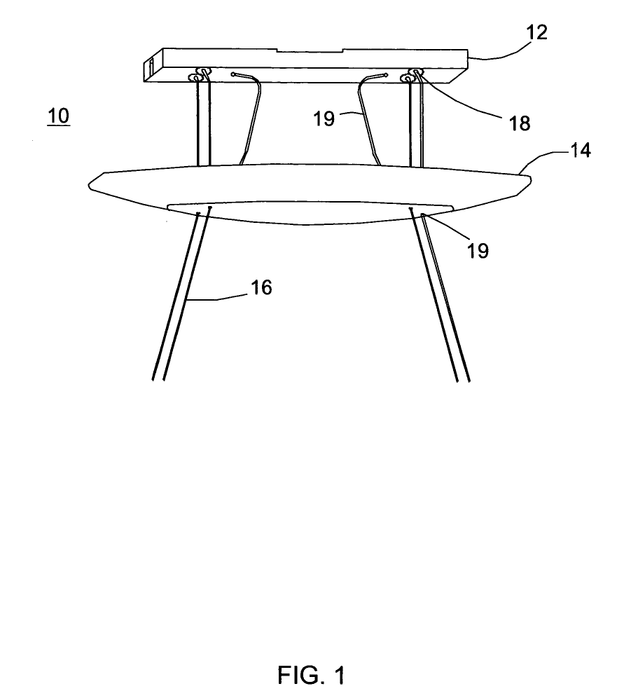

Referring to FIG. 1, a lighting fixture mounting assembly, generally denoted at 10, may comprise a horizontal crossbar 12 secured in any suitable or desired manner to an electrical junction box (not shown) located in the ceiling above the fixture and attached to a joist or other structural member. A canopy 14 fits over and is attached to crossbar 12. Conductive straps 19 may be used to provide a common ground between canopy 14 and crossbar 12.

In the illustrated configuration, electrical apparatus (not shown), which for convenience will be referred to herein as a fixture, is to be suspended by four cables 16 which are anchored to crossbar 12 by suitable gripping hardware 18, then pass through protective and decorative grommets 19 in canopy 14. The lower ends of cables 16 are secured to the fixture itself by suitable grippers (not shown) which may be like or similar to gripping hardware 18.

A suitable construction for mounting assembly 10 may be as illustrated in copending U.S. patent application No. 60/324,888, referred to above, but the present invention may also be used with other types of mounting assemblies.

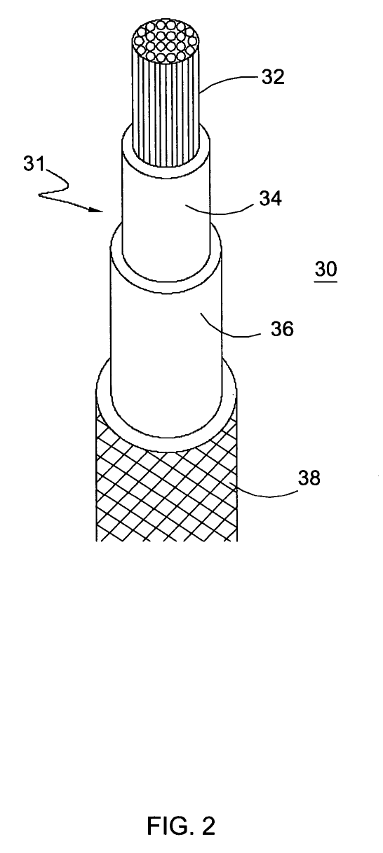

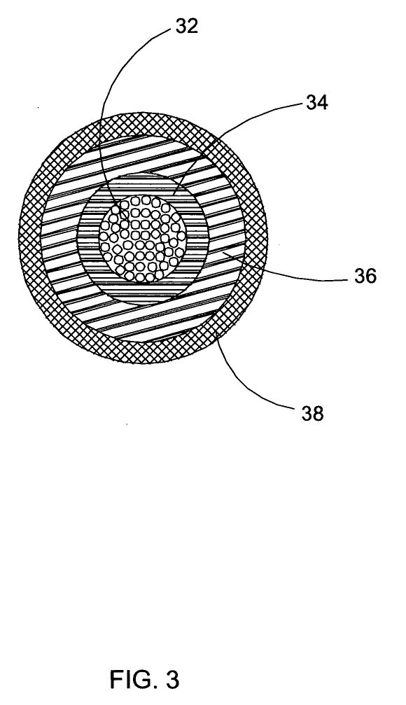

FIGS. 2 and 3 illustrate the construction of the composite cable according to the invention. The cable, generally denoted at 30, is comprised of a central insulated conductor 31 having a core 32 of stranded or solid copper wire, and a layer of electrical insulation 34 surrounding wire 32, a discrete second layer of electrical insulation 36 surrounding insulated conductor 31, and an outer braided-metal or woven-metal layer 38, formed preferably of stainless steel, all substantially coaxial with each other. The insulating layers 34 and 36 are preferably formed of a fluoropolymer such as Teflon® manufactured by E. I du Pont de Nemours and Company. Use of a fluoropolymer material for insulation layers 34 and 36 has several advantages. These include toughness, good insulating properties, high heat-resistance which permits use of thin layers, ease and low cost of manufacture, and ease of handling during wiring. Use of a fluoropolymer insulating material is also advantageous because of its very low coefficient of friction, as discussed below.

Inner insulation layer 34 fits tightly around conductor 32 so there is substantially no slip or relative movement between the two. Preferably, however, insulation layer fits more loosely around central conductor 31 so that slip between the two insulation layers is possible due to the low coefficient of friction. This slip or give between insulation layers 34 and 36 has been found to help prevent the stainless steel sheath 38 from penetrating the insulation and short circuiting wire 32 due to forces applied to it by the gripping hardware. Also, the second layer of insulation 36 minimizes the risk of electrical leakage to the sheath 38 in case of small defects in the insulating layer 34.

It is also possible, depending on the mechanical properties of the insulating material, for the outer insulation layer 36 to fit tightly around inner insulation layer 34, or even to be bonded to it. In such a construction, the second insulating layer may, if desired, be formed of a tough material such as an aramid or fiberglass to minimize the risk of damage to the conductor. The inner insulating layer may be formed of any suitable material.

Inner insulation layer 34 may be applied to conductor 32 in any suitable conventional manner, and maybe at least about 0.001 inch thick, and preferably at least about 0.05 inch thick, and more preferably, at least about 0.01 inch thick, depending on the dielectric and mechanical properties of the insulating material.

Outer insulating layer 36 maybe at least about 0.001 inch thick, preferably at least about 0.05 inch thick, more preferably, at least about 0.01 inch thick, and even more preferably, at least about 0.07 inch thick, again, depending on the dielectric and mechanical properties of the insulating material.

As will be appreciated by persons skilled in the art, use of thinner insulating layers, to the extent permitted by the dielectric and mechanical properties of the insulating material, will result in a smaller overall size for the cable.

Internal conductor 32 is preferably a stranded wire formed of many strands of soft, fine copper. Such wire tends to exhibit little or no memory if the cable is bent, e.g., during shipping or installation, and is accordingly easier to straighten during installation. For an 18 gauge conductor, good results can be obtained using at least 32 strands of 33 gauge soft copper wire, and preferably 168 strands of 40 gauge wire. For a 16 gauge conductor, at least 40 strands of 32 gauge copper should be employed.

It will be understood, however, that solid wire, rather than stranded wire may also be used.

The thickness of outer sheath 38 is determined by the desired maximum diameter of cable 30 in relation to the gauge of conductor 32 and the thickness of the insulating layers. In addition, the rigidity of sheath 38 must not be so great that it is hard to handle or cut or that it has a tendency to unravel excessively when cut. Thus, in the case of stainless steel wire, the gauge must be small. At the same time, weight-bearing requirements must also be taken into account in determining outer diameter. Cables capable of supporting weights of one-half pound and up can be provided.

In a preferred embodiment, the outer diameter of cable 30 is 0.096 inch. For a 25 pound rating, outer sheath 38 may be formed of at least 160 strands of 44 gauge braided or woven stainless steel.

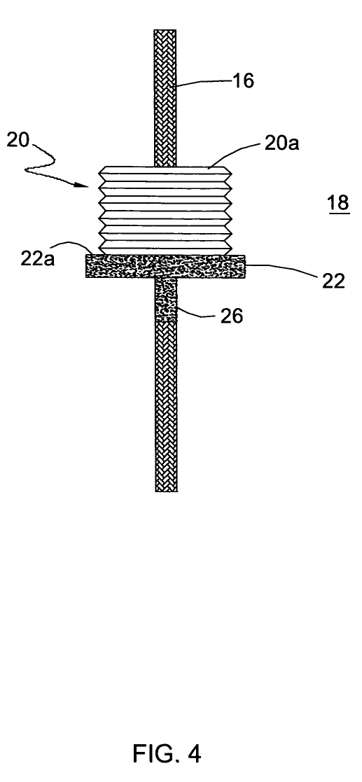

Any suitable gripping hardware 18 may be employed. One such gripper, specifically designed for use with stranded wire suspension cables is manufactured by Arakawa Hanging systems of 1020 SE Harrison, Portland Oreg. As illustrated in FIG. 4, such a gripper comprises a threaded body 20 terminating at one end in an enlarged shoulder 22. A tubular extension 26 protrudes from shoulder 22. A cable 16 extends through tubular extension 26 and out through the opposite end 20a of body 20.

In use, gripper 18 may be oriented so that upper surface 22a of shoulder 22 rests against the underside of crossbar 12, and is secured in place by a nut and a lock washer (not shown). Cable 16 extends upward to permit connection of electrical conductor 32 within the cable 16 as described above to the building wiring in the junction box.

The Arakawa gripper referred to above employs spring biased gripper balls (not shown) which surround cable 16 within a housing defined by body 20 and lock the cable in place against the weight of the suspended fixture. Tubular extension 26 is movable upwardly against the biasing spring to release the pressure of the balls. This allows cable 16, which fits loosely within tubular extension 26, to be repositioned in the “downward” direction (i.e., with gravity). The position of the cable may be adjusted in the upward direction (i.e., against gravity) simply by pulling it up through the housing formed by body 20.

From the foregoing description, it will be appreciated that the cable according to the invention conveniently and reliably addresses the conflicting requirements for a mechanism to support a suspended lighting fixture and also provide electric power to the fixture without the need for an unsightly visible wire.

When formed of thin braided or woven stainless steel wire, the sheath is easy to cut to expose the interior insulating layers using a conventional tool, and will not unravel excessively when cut. The two layers of insulation may also be easily cut so that the conductor may be dressed in a normal manner when wiring the fixture. The outer sheath and cooperating gripper assures reliable weight-bearing, while the two discrete insulating layers reduce the risk of short circuiting of the conductor. At the same time, the metallic sheath provides a common ground between the fixture and the mounting assembly. Also, because it is attached rigidly at both ends, strain relief for the conductor is assured.

As more than one cable will generally be used to suspend a fixture, at least two conductors will always be available to provide a complete electrical circuit. Sometimes, however, four wires maybe needed, e.g., for phase control dimming, or even five wires, e.g., for digital/0-10V dimming, or, in the case of other types of electrical apparatus, for signaling or data. In such instances, or if a single suspension cable is used, more than one conductor may be provided in the cable.

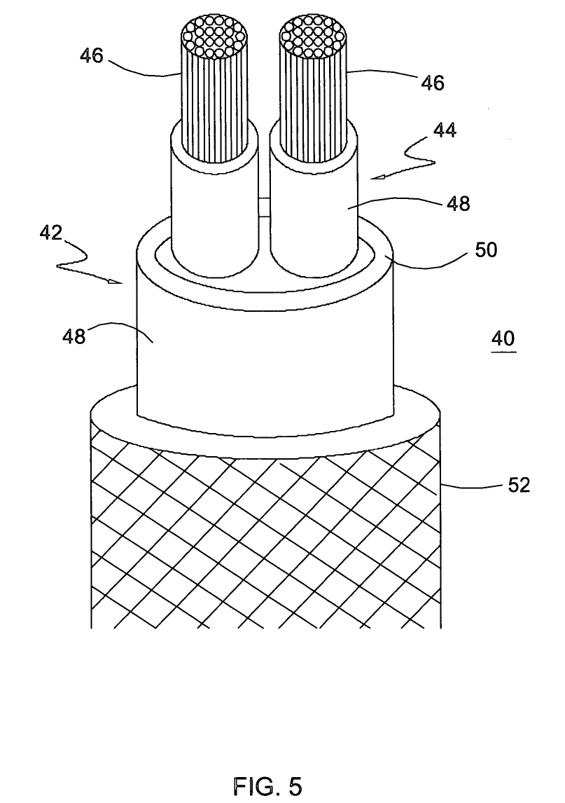

A multi-conductor cable according to the invention is illustrated in FIG. 5. Here, the cable, generally denoted at 40, is comprised of first and second insulated conductors 42 and 44, each comprised of a multi-strand or solid wire 46 and a tightly fitting insulation layer 48, disposed in substantially side-by-side relation. Surrounding conductors 42 and 44 is a discrete insulating layer 50 and an outer braided metal sheath 52. As in the first embodiment, insulation layer 50 fits more loosely around conductors 42 and 44 to permit relative movement. between these elements. Thus, even with a single-cable installation, two conductors will always be available, and with a four-cable installation, any combination of up to eight wires can be provided.

In a dual conductor cable as illustrated in FIG. 5, the side-by-side layout of the conductors may result in a somewhat elliptical or flattened cross-section which may not be held reliably by some grippers. In that case a dummy tube of insulation can be added to provide three internal elements within the second insulating layer to restore the round cross-section.

As will be appreciated by those skilled in the art, other variations are possible within the scope of the invention. For example, insulating layers 34 and 36 can be formed of aramid materials such as Kevlar®, (manufactured by E. I. du Pont de Nemours and Company), or other suitable polymers, fiberglass reinforced materials, etc. having the necessary properties.

Outer sheath 38 can also be manufactured of Kevlar. In that case, an outer jacket or coating may be provided over the Kevlar sheath so it does not unravel excessively when cut and to provide protection from UV radiation. Other suitably strong woven materials such as tin or fiberglass might also be employed. When the weight bearing sheath is not electrically conductive, a thin ground wire may also be included within the sheath, or may be provided in any other suitable manner.

In addition, a thin conventional wire rope (with our without a surrounding insulation layer) can be provided inside the second insulating layer to provide additional weigh-bearing capability.

Although the present invention has been described in relation to a particular embodiment thereof, many other variations and modifications and other uses will become apparent to those skilled in the art. It is intended, therefore, that the invention not be limited by the specific disclosure herein, but that it be given the full scope indicated by the appended claims.

What is claimed is:

1. A combination mounting cable and electrical conductor for a suspended electrical apparatus, the cable being comprised of:
at least one insulated electrical conductor;
a discrete second insulating layer surrounding the insulated conductor, and movable relative to the insulated conductor; and
a sheath surrounding the second insulating layer, the sheath being capable of bearing the weight of an electrical device suspended by the cable.

2. A cable according to claim 1, wherein the insulation on the conductor and the discrete second insulating layer are formed of a fluoropolymer material.

3. A cable according to claim 1, wherein the insulation on the conductor has a thickness of at least approximately 0.01 inch.

4. A cable according to claim 1, wherein the discrete second insulating layer has a thickness of at least approximately 0.07 inch.

5. A cable according to claim 1, wherein the sheath is formed of braided or woven metal.

6. A cable according to claim 1, wherein the insulated conductor is formed of at least 32 strands of 33 gauge copper wire.

7. A cable according to claim 1, wherein the insulated conductor is formed of about 168 strands of 40 gauge copper wire.

8. A cable according to claim 1, wherein the sheath is formed of at least 160 strands of 44 gauge braided or woven stainless steel.

9. A cable according to claim 1, wherein the second insulating layer is movable relative to the insulated conductor and relative to the sheath.

10. A cable according to claim 1, further including at least a second insulated electrical conductor located within the discrete second insulating layer, and movable relative thereto.

11. A cable according to claim 10, wherein the insulated conductors are disposed in substantially side-by-side relation in the cable.

12. A cable according to claim 10, wherein the discrete second insulating layer is movable relative to the first and second insulated conductors.

13. A cable according to claim 1, wherein the discrete second insulating layer protects against electrical leakage to the sheath in case of small defects in the insulation of or damage to the conductor.

14. A cable according to claim 1, wherein the insulated electrical wire is solid.

15. A cable according to claim 1, wherein the insulated electrical wire is stranded.

16. A cable according to claim 1, wherein the sheath is formed of stainless steel.

17. A cable according to claim 1, wherein the sheath is formed of braided or woven aramid fiber.

18. A cable according to claim 1, wherein the discrete second insulating layer is formed of an aramid material.

19. A cable according to claim 1, wherein the insulation on the conductor has a thickness of at least about 0.001 inch.

20. A cable according to claim 1, wherein the insulation on the conductor has a thickness of at least about 0.005 inch.

21. A cable according to claim 1, wherein the discrete second insulating layer has a thickness of at least about 0.001 inch.

22. A cable according to claim 1, wherein the discrete second insulating layer has a thickness of at least about 0.005 inch.

23. A cable according to claim 1, wherein the discrete second insulating layer has a thickness of at least about 0.01 inch.

24. A cable according to claim 1, further including at least a second insulated electrical conductor located within the discrete second insulating layer.

25. A cable according to claim 24, wherein the insulated conductors are disposed in substantially side-by-side relation in the cable.

26. A cable according to claim 24, wherein the discrete second insulating layer is movable relative to the first and second insulated conductors.

27. A cable according to claim 1, wherein the discrete second insulating layer is substantially immovable relative to the first and second insulated conductors.

28. A cable according to claim 1, wherein the discrete second insulating layer is formed of fiberglass.

29. A cable according to claim 1, wherein the discrete second insulating layer is formed of an aramid material or fiberglass.

30. A cable according to claim 29, wherein the discrete second insulating layer is substantially immovable relative to the insulated conductor.

31. A cable according to claim 1, wherein the discrete second insulating layer is bonded to the insulated conductor.
